(19) United States
(12) Patent Application Publication
(10) Pub. No.: US 2008/0137142 A1
(43) Pub. Date: Jun. 12, 2008

(54) IMAGE PROCESSING APPARATUS, IMAGE PROCESSING METHOD AND MEDIA FOR COMPUTER PROGRAM THEREOF

(75) Inventor: Eun-hui JUNG, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/943,696

(22) Filed: Nov. 21, 2007

(30) Foreign Application Priority Data
Dec. 8, 2006 (KR) 2006-124794

(51) Int. Cl. G06K 15/00

(52) U.S. Cl. 358/1.18

(57) ABSTRACT

An image processing apparatus including an extracting portion to extract a print object from print data based on a selection from list information included in the print data, an image processing portion to perform an image processing operation to output the print object and a controller to control the image processing portion to extract the print object based on the selection from the list information by a user, to select a layout corresponding to the extracted print object, and to output the extracted print object according to the selected layout.

### CROSS-REFERENCE TO RELATED APPLICATIONS

This application claims priority under 35 U.S.C. §119(a) from Korean Patent Application No. 10-2006-0124794, filed on Dec. 8, 2006 in the Korean Intellectual Property Office, the disclosure of which is incorporated herein in its entirety by reference.

### BACKGROUND OF THE INVENTION

1. Field of the Invention

Apparatus and method consistent with the present general inventive concept relates to an image processing apparatus, and more particularly, to an image processing apparatus to select a print region to be output, an image processing method and a medium for recording a computer program containing the image processing method.

2. Description of the Related Art

An image processing apparatus performs an image processing operation for converting print data prepared by a computer program to an image that is output to a medium. If the print data prepared by the computer program comprises a plurality of pages, a user can select a page that includes desired print data to be output by a related option.

However, when only a portion of the selected page is desired to be output, it is troublesome for a user to check what other contents are included in the selected page. In addition, since unwanted information by the user is included in the selected print page, toner and/or paper may be wasted.

### SUMMARY OF THE INVENTION

The present general inventive concept provides an image processing apparatus and an image processing method, which are capable of printing user desired information according to various layouts, thereby saving toner and/or paper by extracting a selection from list information included in print data and outputting only a portion of the print data corresponding to the selection from the list information by the user.

Additional aspects and utilities of the present general inventive concept will be set forth in part in the description which follows and, in part, will be obvious from the description, or may be learned by practice of the present general inventive concept.

The foregoing and/or other aspects and utilities of the present general inventive concept can be achieved by providing an image processing apparatus comprising an extracting portion to extract a print object from print data based on a selection from list information included in the print data, an image processing portion to perform an image processing operation to output the print object and a controller to control the image processing portion to extract the print object based on the selection from the list information by a user, to select a layout corresponding to the extracted print object, and to output the extracted print object according to the selected layout.

The image processing apparatus may further comprise a user input portion, wherein the controller receives an instruction on the selection from the list information and a selection of the layout from the user input portion.

The image processing apparatus may further comprise a display portion, and a user interface (UI) generating portion, wherein the controller controls the UI generating portion to generate a user interface for the selection from the list information and the selection of the layout and controls the display portion to display the generated user interface.

The layout may output the extracted print object according to a predetermined order.

The layout may output the selected print object and a print object, which is not selected, together.

The layout may output the selected print object highlighted in comparison with a print object which is not selected.

The controller may control the display portion to perform a preview function for the processed print object.

The print data may comprise image data.

The foregoing and/or other aspects and utilities of the present general inventive concept can also be achieved by providing an image processing method of an image processing apparatus comprising making a selection from list information included in print data by a user, extracting a print object of the print data based on the selection from the list information, selecting a layout corresponding to the extracted print object and outputting the extracted print object according to the selected layout.

The layout may output the extracted print object according to a predetermined order.

The layout may output the selected print object and a print object, which is not selected, together.

The layout may output the selected print object highlighted in comparison with the print object which is not selected.

The outputting of the extracted print object may further comprise performing a preview function for the processed print object.

The print data may comprise image data.

The foregoing and/or other aspects and utilities of the present general inventive concept can also be achieved by providing a computer-readable recording medium having embodied therein a computer program to execute a method, wherein the method comprises making a selection from list information included in print data by a user, extracting a print object of the print data based on the selection from the list information, selecting a layout corresponding to the extracted print object and outputting the extracted print object according to the selected layout.

The layout may output the extracted print object according to a predetermined order.

The layout may output the selected print object and a print object, which is not selected, together.

The layout may output the selected print object highlighted in comparison with the print object which is not selected.

The outputting of the extracted print object may further comprise performing a preview function for the processed print object.

The print data may comprise image data.

The foregoing and/or other aspects and utilities of the general inventive concept may also be achieved by providing an image processing apparatus comprising a display to display print data having one or more individually selectable groups of information, a user interface to allow a user to select the one or more individually selectable groups of information, and a controller to extract only a portion of the print data based on a selection of the one or more individually selectable groups of information, to select a layout corresponding to the extracted portion of print data, and to output the extracted portion of print data according to the selected layout.

The foregoing and/or other aspects and utilities of the general inventive concept may also be achieved by providing an image processing method comprising displaying print data having one or more individually selectable groups of information, selecting the one or more individually selectable groups of information, extracting only a portion of the print data based on a selection of the one or more individually selectable groups of information, selecting a layout corresponding to the extracted portion of print data and outputting the extracted portion of print data according to the selected layout.

### BRIEF DESCRIPTION OF THE DRAWINGS

These and/or other aspects and utilities of the present general inventive concept will become apparent and more readily appreciated from the following description of the embodiments, taken in conjunction with the accompanying drawings, in which:

FIG. 1 is a block diagram illustrating a configuration of an image processing apparatus according to an exemplary embodiment of the present general inventive concept;

FIGS. 2A and 2B are views illustrating a user interface of the image processing apparatus according to the exemplary embodiment of the present general inventive concept;

FIGS. 3A and 3B are views illustrating examples of an image processed by the image processing apparatus according to the exemplary embodiment of the present general inventive concept; and

FIG. 4 is a flow chart illustrating an image processing method according to an exemplary embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to like elements throughout. The embodiments are described below in order to explain the present general inventive concept by referring to the figures.

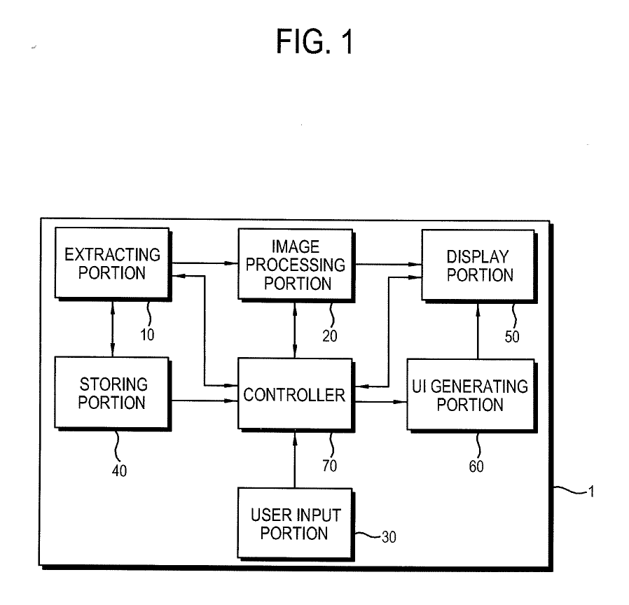

FIG. 1 is a block diagram illustrating a configuration of an image processing apparatus 1 according to an exemplary embodiment of the present general inventive concept. As illustrated in FIG. 1, the image processing apparatus 1 comprises an extracting portion 10, an image processing portion 20 and a controller 70. The image processing apparatus 1 may further comprise a user input portion 30, a storing portion 40, a display portion 50 and a user interface (UI) generating portion 60. The image processing apparatus 1 may be embodied by a printer and other known devices.

The extracting portion 10 extracts a print object of print data based on list information included in the print data. That is, the list information can be individually selectable groups of information arranged in a column, row, table, or randomly, for example, on a display to allow a user to make a selection of one or more individually selectable groups of information. In this embodiment, the extracting portion 10 may receive the print data, for example, in a file. A print data file, for example, can have a structured document format such as Portable Document Format (PDF) or XML Paper Specification (XPS) including the list information. In this embodiment, the extracting portion 10 extracts the list information such as index information, hyperlink information, bookmark information and the like from the print data file under control of the controller 70, which will be described later.

Here, the list information is provided from contents of the file having the structured document format on a basis of a structural characteristic irrespective of a number of pages. Further, the list information is provided at the same time as when contents of the file are created. The list information may include structural information like a paragraph of text or information as a unit of a resource object like an image. Each structural contents-information has a hierarchical structure. For example, one contents-information may include concrete sub-contents information. That is, one paragraph may include a plurality of sub-paragraphs or a plurality of sub-resource objects such as an image.

Meanwhile, a title or an index is given to each contents-information of the list information, so that a user can gain insight as to the contents of the respective contents-information with reference to the title or the index of the contents-information.

The image processing portion 20 performs an image processing operation to output the print data. In this embodiment, the image processing portion 20 comprises a photoconductor (not illustrated) on which an electrostatic latent image is formed, a developing unit (not illustrated) to develop the electrostatic latent image on the photoconductor with a developer, and a transfer roller (not illustrated) to transfer the developed electrostatic latent image to a printing medium such as paper on which an image is printed.

The user input portion 30 is input with an instruction to select a layout to output the list information and the print object included in the print data from a user. In this embodiment, the user input portion 30 is provided at one side of the image processing apparatus 1, but the user input portion 30 may be provided in an external computer input with an instruction to select a layout to output the list information and the print object included in the print data from the outside.

In addition, in this embodiment, the user input portion 30 may be embodied by a wireless remote controller that may be provided with a menu key and a key signal generating portion to generate a key signal when a key is pushed.

The storing portion 40 stores the list information and the corresponding print object extracted by the extracting portion 10. In this embodiment, the storing portion 40 may be embodied by a nonvolatile memory such as a flash memory, or a hard disk.

The display portion 50 displays a user interface (UI) to select the layout to output the list information and the print object, which is generated by the UI generating portion 60. In addition, the display portion 50 can perform a preview function for the print object processed under control of the controller 70 which will be described later. In this embodiment, the display portion 50 may be embodied by a light emitting diode (LED), a liquid crystal display (LCD) panel or other known devices in the art.

As described above, the UI generating portion 60 generates the UI to select the layout to output the list information and the print object included in the print data. The UI will be described in detail later.

In this embodiment, the storing portion 40, the display portion 50 and the UI generating portion 60 may be provided not only in the image processing apparatus 1, like the user input portion 30, but also in an external computer that is able to control the image processing apparatus 1.

The controller 70 controls the extracting portion 10 to extract the print object based on the list information selected by the user and controls the image processing portion 20 to select a layout to output the extracted print object and output the extracted print object according to the selected layout.

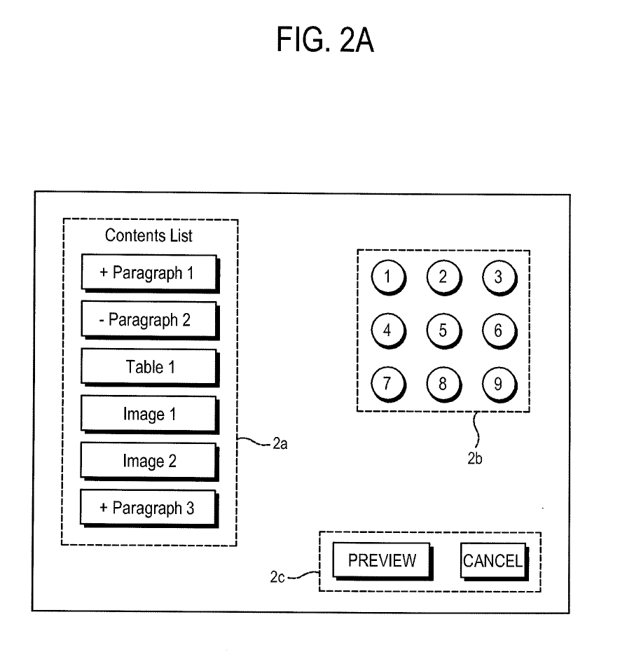

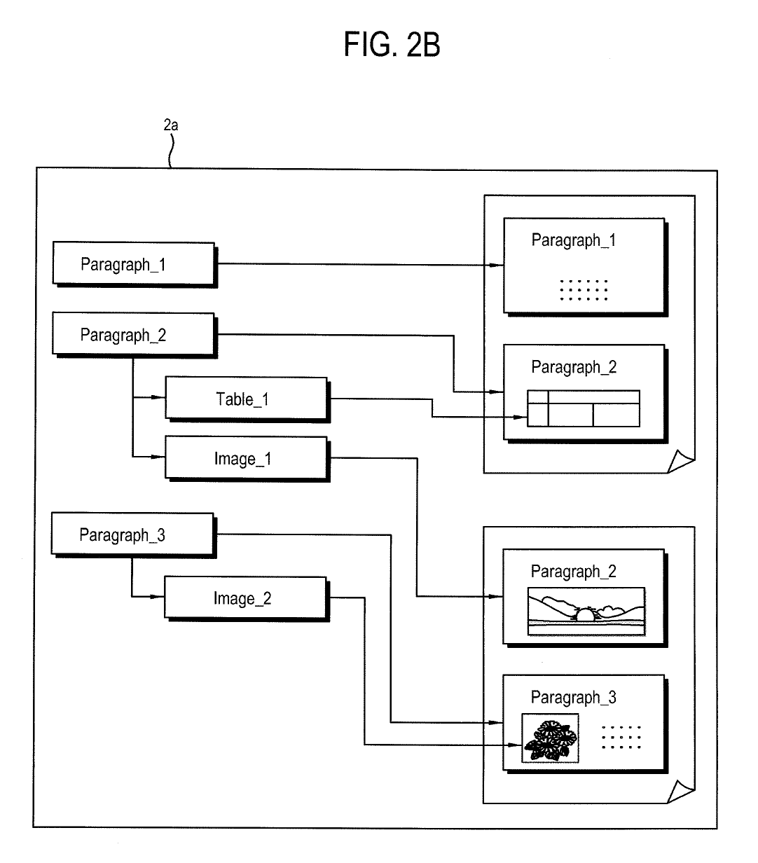

Hereinafter, an operation of the controller 70 will be described with reference to FIGS. 2A and 2B illustrating user interfaces.

FIG. 2A illustrates a user interface to select the print object in the list information that are included in the print data and to select a the layout to output the selected print object in the image processing apparatus 1 according to the exemplary embodiment of FIG. 1.

Referring to FIGS. 1 and 2A, when a user selects the print object from the list information, the controller 70 controls the UI generating portion 60 to extract the selected print object and generates the user interface 2a to display the list information included in the print data. The print data may be input to the controller 70 in a form of a file, and the extracted print object from the list information may have a hierarchical structure such as a tree structure. In addition, the print object in the list information may comprise an image, a table as well as text. The user may select ay form of the print object from the list information.

When the print object in the list information is selected through the user interface 2a displaying the list information, the controller 70 controls the image processing portion 20 to output the print object corresponding to the selection from the list information. Accordingly, the print object from the list information may be selected in plural. When the plural print objects are selected from the list information, a layout to output the print objects may be selected through an interface 2b for layout selection.

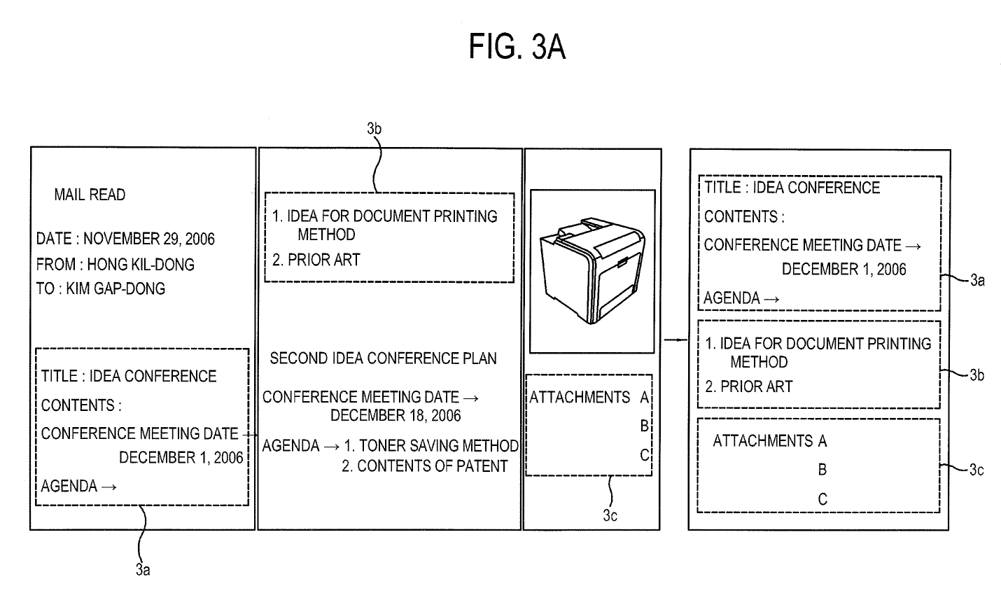

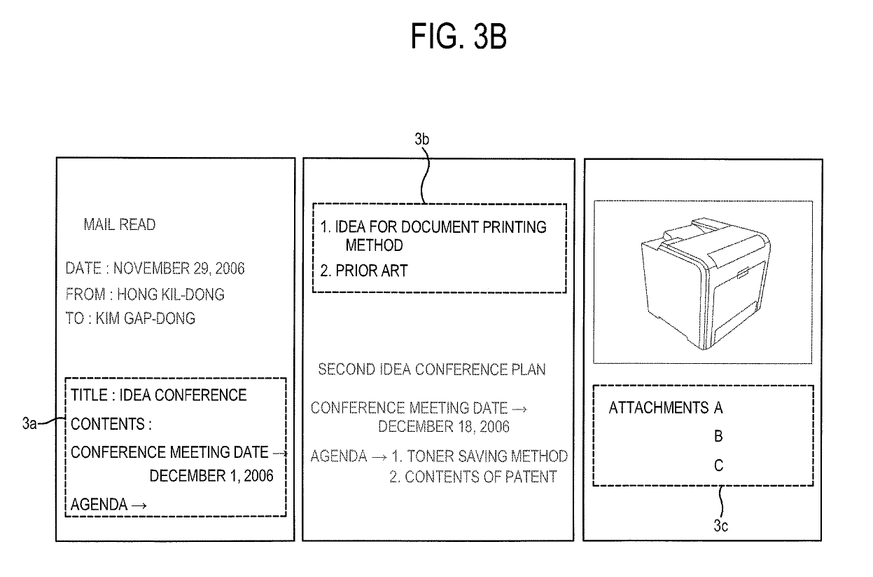

Specifically, when the user provides a serial order to the print objects in the list information using number keys displayed in the layout selection interface 2b, the controller 70 controls the image processing portion 20 to output the printed objects selected by the user according to the provided serial order. In addition, the controller 70 may control the image processing portion 20 to select the print objects to be output in a highlighted mode in comparison with the print objects not selected by the user. The layout to output the print object will be described in more detail with reference to FIGS. 3A and 3B.

In this embodiment, the controller 70 controls the display portion 50 to display the print object processed by the image processing portion 20 to preview the print object through a user interface 2c according to the layout selected by the user so that the user can output the print object with the desired layout without difficulty.

FIG. 2B illustrates a user interface illustrating the list information extracted from the print data. As illustrated in FIG. 2B, the print data includes three paragraphs, in which a first paragraph Paragraph_1 includes a text; a second paragraph Paragraph_2 includes a table Table_1 and an image Image_1; and a third paragraph Paragraph_3 includes an image Image_2.

That is, the extracted list information is created according to the contents of the print data independent of how many pages of the respective page the print data is on, and each contents-information of the list information is illustrated as a title or an index, thereby allowing a user to gain insight to the contents-information.

Hereinafter, the layout to output the print object in the image processing apparatus 1 will be described in more detail with reference to FIGS. 3A and 3B.

FIG. 3A is a view illustrating a layout to output only print objects (3a, 3b, 3c) corresponding to a user selection in the list information according to the exemplary embodiment of FIG. 1. Referring to FIGS. 2A and 3A, the user may select the desired print objects from the list information through the user interface 2a displaying the list information and provide a serial number to set an order to output the selected print objects through the layout selection interface 2b. Thus, only the desired print objects may be output, thereby saving toner and/or paper.

In this embodiment, although the controller 70 (FIG. 1) may recombine and output the print objects corresponding to the selection from the list information selected by the user, as illustrated in FIG. 3A, the controller 70 may also control the image processing portion 20 to output the print objects at their original positions without recombining the selected print objects.

FIG. 3B is a view illustrating a highlighted layout to output print objects selected by the user in comparison with print objects not selected by the user. Referring to FIGS. 2A and 3B, the user may select the desired print objects from the list information through the user interface 2a displaying the list information and set an option to highlight the selected data objects in the list information using a menu button or the like included in the layout selection interface 2b.

The controller 70 may control the print data to be output according to a layout to output the entire print data irrespective of the list information included in the print data.

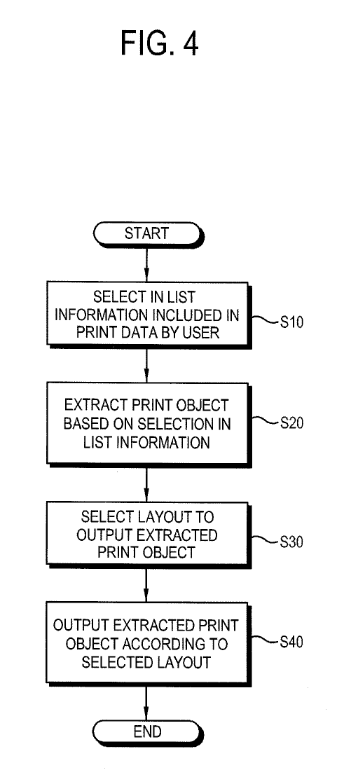

Hereinafter, an image processing method according to an exemplary embodiment of the present general inventive concept will be described with reference to FIG. 4.

First, the controller 70 receives information on the user selection from the list information included in print data at operation S10. Then, the controller 70 controls the extracting portion 10 to extract the print object of the print data based on the selection in the list information at operation S20. Next, the controller 70 selects a layout to output the extracted print object at operation S30.

In this embodiment, the layout to output the selected print object may comprise a layout to output only the selected print object in a predetermined order, a layout to output the selected print object highlighted in comparison with print objects not selected, and a layout to output both of the selected print object and the print object not selected.

Next, the controller 70 controls the image processing portion 20 to output the extracted print object according to the selected layout at operation S40. In this embodiment, the controller 70 may control the display portion 50 to perform a preview function for the print object processed by the image processing portion 20.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As apparent from the above description, various embodiments of the present general inventive concept provide an image processing apparatus and an image processing method, which are capable of printing only user desired information according to various layouts, thereby toner and/or paper.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. An image processing apparatus, comprising:
an extracting portion to extract a print object from print data based on a selection from list information included in the print data;
an image processing portion to perform an image processing operation to output the print object; and
a controller to control the image processing portion to extract the print object based on the selection from the list information by a user, to select a layout corresponding to the extracted print object, and to output the extracted print object according to the selected layout.

2. The image processing apparatus according to claim 1, further comprising:
a user input portion,
wherein the controller receives an instruction on the selection from the list information and a selection of the layout from the user input portion.

3. The image processing apparatus according to claim 2, further comprising:
a display portion; and
a user interface (UI) generating portion,
wherein the controller controls the UI generating portion to generate a user interface for the selection from the list information and the selection of the layout and controls the display portion to display the generated user interface.

4. The image processing apparatus according to claim 1, wherein the layout outputs the extracted print object according to a predetermined order.

5. The image processing apparatus according to claim 1, wherein the layout outputs the selected print object and a print object, which is not selected, together.

6. The image processing apparatus according to claim 1, wherein the layout outputs the selected print object highlighted in comparison with a print object which is not selected.

7. The image processing apparatus according to claim 3, wherein the controller controls the display portion to perform a preview function for the processed print object.

8. An image processing method of an image processing apparatus, the method comprising:
making a selection from list information included in print data;
extracting a print object of the print data based on the selection from the list information;
selecting a layout corresponding to the extracted print object; and
outputting the extracted print object according to the selected layout.

9. The image processing method according to claim 8, wherein the layout outputs the extracted print object according to a predetermined order.

10. The image processing method according to claim 8, wherein the layout outputs the selected print object and a print object, which is not selected, together.

11. The image processing method according to claim 10, wherein the layout outputs the selected print object highlighted in comparison with the print object which is not selected.

12. The image processing method according to claim 8, wherein the outputting of the extracted print object further comprises:
performing a preview function for the processed print object.

13. A computer-readable recording medium having embodied thereon a computer program to execute a method, wherein the method comprises:
making a selection from list information included in print data;
extracting a print object of the print data based on the selection from the list information;
selecting a layout corresponding to the extracted print object; and
outputting the extracted print object according to the selected layout.

14. The method according to claim 13, wherein the layout outputs the extracted print object according to a predetermined order.

15. The method according to claim 13, wherein the layout outputs the selected print object and a print object, which is not selected, together.

16. The method according to claim 13, wherein the outputting of the extracted print object further comprises:
performing a preview function for the processed print object.

17. An image processing apparatus, comprising:
a display to display print data having one or more individually selectable groups of information;
a user interface to allow a user to select the one or more individually selectable groups of information; and
a controller to extract only a portion of the print data based on a selection of the one or more individually selectable groups of information, to select a layout corresponding to the extracted portion of print data, and to output the extracted portion of print data according to the selected layout.

18. The image processing apparatus according to claim 17, wherein the portion of print data comprises:
one or more print objects.

19. The image processing apparatus according to claim 18, wherein the user interface allows the user to select an order in which the one or more print objects are output.

20. An image processing method, comprising:
displaying print data having one or more individually selectable groups of information;
selecting the one or more individually selectable groups of information;
extracting only a portion of the print data based on a selection of the one or more individually selectable groups of information,
selecting a layout corresponding to the extracted portion of print data; and
outputting the extracted portion of print data according to the selected layout.
